(19) United States
(12) Patent Application Publication
(10) Pub. No.: US 2013/0286125 A1
(43) Pub. Date: Oct. 31, 2013

(54) MEDIUM RECEIVING DEVICE AND RECORDING APPARATUS

(71) Applicant: SEIKO EPSON CORPORATION, Tokyo (JP)

(72) Inventors: Hideo Mikuriya, Suwa-shi (JP); Naohiro Ueyama, Matsumoto-shi (JP)

(73) Assignee: SEIKO EPSON CORPORATION, Tokyo (JP)

(21) Appl. No.: 13/793,625

(22) Filed: Mar. 11, 2013

(30) Foreign Application Priority Data
Apr. 27, 2012 (JP) 2012-102533

(51) Int. Cl. B41J 13/10

(52) U.S. Cl. CPC B41J 13/106
USPC 347/104; 271/207

(57) ABSTRACT

A medium receiving device includes a support shaft that extends in a width direction of the sheet and supports a medium holding member that is capable of receiving and holding the sheet which falls on the medium holding member, a rotative arm mechanism that is disposed at each end of the support shaft in the longitudinal direction and allows the support shaft to be displaced between a receiving position that allows the medium holding member to be capable of receiving the sheets and a picking-up position that is spaced from the receiving position in a direction that intersects with the longitudinal direction of the support shaft, and a universal joint that connect the support shaft and the rotative arm mechanism.

### BACKGROUND

1. Technical Field

The present invention relates to a medium receiving device that receives media which have been ejected and fallen into the medium receiving device at a lower position in the gravity direction and a recording apparatus having the medium receiving device.

2. Related Art

Ink jet printers are known as an example of recording apparatus that performs recording on a medium. JP-A-2010-215367 discloses a configuration of a printer in which recording is performed by ejecting ink from a recording head in a recording unit onto a long sheet-shaped medium which is unwound from a roll of the medium and is transported through the recording unit, and then the medium is cut at a predetermined length and is ejected from the printer.

That is, the printer described in JP-A-2010-215367 includes a recording unit that performs recording on a sheet (medium), and a sheet storing unit (medium receiving device) that receives and stores the sheets at a position lower than a paper ejection guide when the sheets are ejected from the paper ejection guide which is disposed at a position downstream to the recording unit and fallen in an obliquely forward direction into the sheet storing unit. The sheet storing unit of this printer includes a pair of support members disposed on each side of the sheet in the width direction of the sheet, a shaft supported by the pair of support members at each end of in the longitudinal direction, and a sheet receiving member (medium holding member) that is hung over the shaft so as to receive and hold the sheets that have been ejected and fallen from the medium ejection unit. The shaft is capable of being displaced between a receiving position in which the shaft is spaced forward from the medium ejection unit in a direction that intersects with the vertical direction so that sheets which have been ejected and fallen from the medium ejection unit are received by the sheet receiving member, and a storing position in which the shaft is positioned at the back of the receiving position and under the paper ejection guide so that the shaft is within an installation area of the recording unit.

In the above-mentioned printer, a holding force for holding the shaft at the receiving position with the sheet receiving member being hung over needs to be increased so that a plurality of sheets are loaded and stored on the sheet receiving member of the sheet storing unit. In this case, however, a load is applied to the shaft when it is displaced against the holding force. As a result, it is difficult to move both ends of the shaft simultaneously from the receiving position to the storing position which is a non-receiving position.

Moving each end of the shaft one by one from the receiving position to the storing position could be possible. In this case, however, distortion occurs between the shaft and the support member, which may cause a problem that the support member is broken.

Such a problem is not limited to the above-mentioned ink jet printer and the medium receiving device of the printer, but is generally common to recording apparatuses that receive media that have been ejected and fallen from a medium ejection unit such that the media are received at a position lower than the medium ejection unit in the gravity direction and recording apparatuses having the medium receiving device.

### SUMMARY

An advantage of some aspects of the invention is that a medium receiving device that allows the support member that supports the medium holding member capable of receiving and holding the ejected medium to be displaced in a stable manner between a first position in which medium holding member is capable of receiving the medium and a second position in which the medium holding member is not capable of receiving the medium, and a recording apparatus having the medium receiving device are provided.

According to an aspect of the invention, a medium receiving device that receives a medium which is ejected and falls from a medium ejection unit at a position lower than the medium ejection unit in the gravity direction includes a support member that extends in a width direction of the medium that intersects with an ejection direction of the medium at a position spaced from the medium ejection unit and supports a medium holding member that is capable of holding the medium which falls on the medium holding member, a displacement mechanism that is disposed at each end of the support member in the longitudinal direction and allows the support member to be displaced between a first position in which the medium holding member is capable of receiving the medium and a second position which is spaced from the first position in a direction that intersects with the longitudinal direction of the support member, and a pair of connection members that connect the support member and the displacement mechanism, wherein the pair of connection members are configured to deform to a first connection state in which the support member and the displacement mechanism are connected in a coaxial arrangement in the width direction of the medium and a second connection state in which the support member and the displacement mechanism are connected in a non-coaxial arrangement in the width direction of the medium.

With this configuration, even if the support member is inclined during a process in which each end of the support member in the longitudinal direction is displaced one by one from the first position to the second position, the support member and the displacement mechanism remain to be connected since the pair of connection members deform as the support member is inclined. Accordingly, even if the holding force for holding the support member at the first position is increased in order to hold the media in a stable manner, it is possible to displace each end of the support member in the longitudinal direction one by one from the first position to the second position while the support member and the displacement mechanism remain to be connected. Accordingly, the support member that supports the medium holding member capable of receiving and holding the ejected medium can be displaced in a stable manner between the first position that allows the medium holding member to be capable of receiving the medium and the second position that allows the medium holding member not to be capable of receiving the medium.

In the medium receiving device according to the above-mentioned aspect of the invention, in a state that one end of the support member in the longitudinal direction is positioned at the first position and the other end of the support member in the longitudinal direction is positioned at the second position, a distance between each of the pair of connection members is smaller than a dimension of the support member in the longitudinal direction.

With this configuration, when each end of the support member in the longitudinal direction is displaced one by one from the first position to the second position, the end of the support member is not disengaged from the connection member. Accordingly, when the support member is displaced from the first position to the second position, a configuration can be achieved in which the support member and the displacement mechanism can remain to be connected by the pair of connection members.

In the medium receiving device according to the above-mentioned aspect of the invention, the second position is located within an installation area of the medium ejection unit when the support member projects the medium ejection unit in the gravity direction.

With this configuration, even if the holding force for holding the support member at the first position is increased in order to hold the medium in a stable manner, handleability of the support member being displaced from the first position to the second position can be increased by displacing each end of the support member in the longitudinal direction one by one from the first position to the second position.

In the medium receiving device according to the above-mentioned aspect of the invention, the second position is spaced from the medium ejection unit in the direction that intersects with the longitudinal direction of the support member by a distance larger than the first position.

With this configuration, even if the holding force for holding the support member at the first position is increased in order to hold the medium in a stable manner, handleability of the support member being displaced from the first position to the second position can be increased by displacing each end of the support member in the longitudinal direction one by one from the first position to the second position.

According to another aspect of the invention, a recording apparatus includes a recording unit that performs recording on a medium, and medium receiving device of the above-mentioned configuration that receives the medium on which recording has been performed by the recording unit. With this configuration, a similar effect to that of the invention of the medium receiving device can be obtained.

### BRIEF DESCRIPTION OF THE DRAWINGS

The invention will be described with reference to the accompanying drawings, wherein like numbers reference like elements.

FIG. 1 is a perspective view of a recording apparatus according to an embodiment of the invention.

FIG. 2 is a side view of the recording apparatus according to the embodiment which shows that a support shaft is in a receiving position.

FIG. 3 is a side view of the recording apparatus according to the embodiment which shows that the support shaft is in a storing position.

FIG. 4 is a side view of the recording apparatus according to the embodiment which shows that the support shaft is in a picking-up position.

FIG. 5 is a front view of the recording apparatus according to the embodiment which shows that the support shaft is in the receiving position.

FIG. 6 is a front view of the recording apparatus according to the embodiment which shows that the support shaft is moving from the receiving position to the picking-up position.

FIG. 7 is an enlarged view of an essential part of FIG. 6.

FIG. 8 is a front view of the recording apparatus according to the embodiment which shows that the support shaft is in the picking-up position.

FIG. 9 is an enlarged view of an essential part of a recording apparatus according to another embodiment of the invention.

### DESCRIPTION OF EXEMPLARY EMBODIMENTS

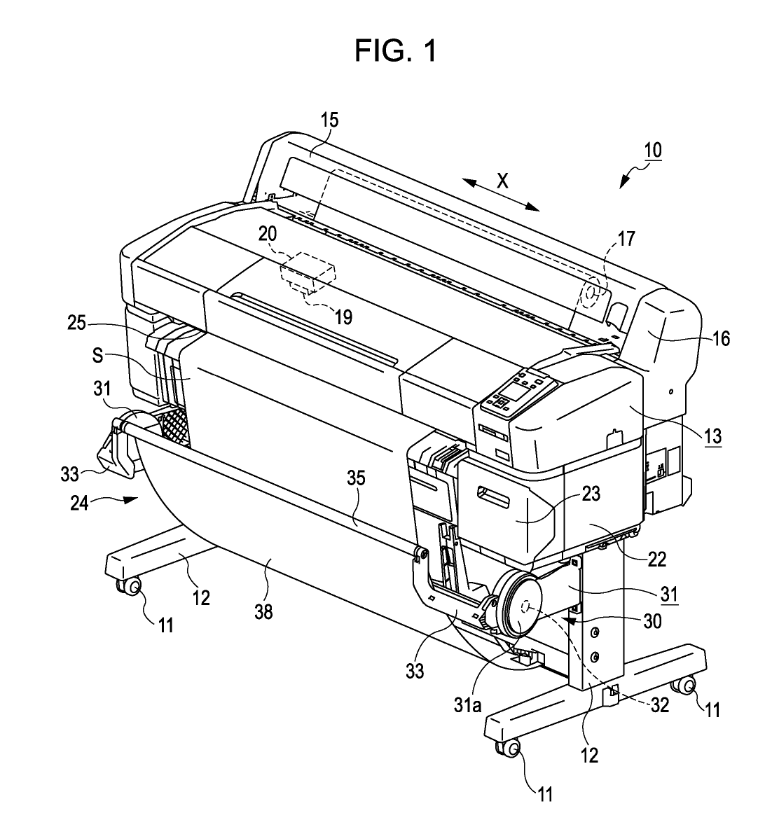

As shown in FIG. 1, a recording apparatus 10 includes a pair of legs 12 each having an inverted T-shape in side view with a pair of caster wheels 11 capable of running on a floor surface being mounted on the lower end of the respective legs 12, and an apparatus body 13 that is placed on and assembled to the pair of legs 12.

The apparatus body 13 is formed in a substantially cuboid shape that extends in a width direction of a sheet S which is an example of a medium and a sheet feeding unit 16 that extends obliquely upward from the back side of the apparatus body 13 and supports a roll sheet holder 15.

A roll of sheet paper S is rotatably held by a rotation shaft 17 in the roll sheet holder 15. When the rotation shaft 17 rotates by driving a feed motor, which is not shown in the figure, the sheet S unwound from the roll is fed into the apparatus body 13.

A carriage 20 is disposed in the apparatus body 13 so as to reciprocate in a main scan direction X. A recording head 19 which is an example of a recording unit is mounted on the carriage 20. In the apparatus body 13, a plurality of pairs of transportation rollers (not shown in the figure) that are driven by a transportation motor, which is not shown in the figure, to transport the sheet S fed out from the sheet feeding unit 16. The recording apparatus 10 performs recording of an image according to print data on the sheet S by substantially alternatively repeating a recording operation for one scan in which ink droplets are ejected from the recording head 19 while the carriage 20 moves in the main scan direction X and a transportation operation in which the sheet S is transported to the next recording position.

Further, a cartridge container 22 having a front opening that contains a plurality of ink cartridges (not shown in the figure) and a cover 23 that openably covers the front opening of the cartridge container 22 are provided on the front side of the apparatus body 13 at one end in the longitudinal direction of the apparatus body 13 (the right end in FIG. 1). The cover 23 rotates in the forward and backward direction about a rotation shaft (not shown in the figure) that extends in the longitudinal direction of the apparatus body 13 at a lower end of the cover 23, thereby uncovering the opening of the cartridge container 22. When the recording head 19 ejects ink from the ink cartridges of the cartridge container 22, printing is performed on the sheet S.

Further, a rotation cutter (not shown in the figure) is provided in the apparatus body 13 at a position downstream with respect to the recording head 19 in the transportation direction of the sheet S so as to move in the width direction of the sheet S. The rotation cutter separates the sheet S into pieces of a predetermined length by cutting the sheet S in the thickness direction while moving in the width direction of the sheet S.

A medium receiving unit 24 as an example of a medium receiving device that receives the sheets S after printing is performed is disposed on the lower side of the apparatus body 13. The medium receiving unit 24 receives the sheets S which have been ejected and fallen from an ejection port 25 that is open to the front side of the apparatus body 13 which is an example of a medium ejection unit such that the sheets S are received at a position lower than the apparatus body 13 in the gravity direction.

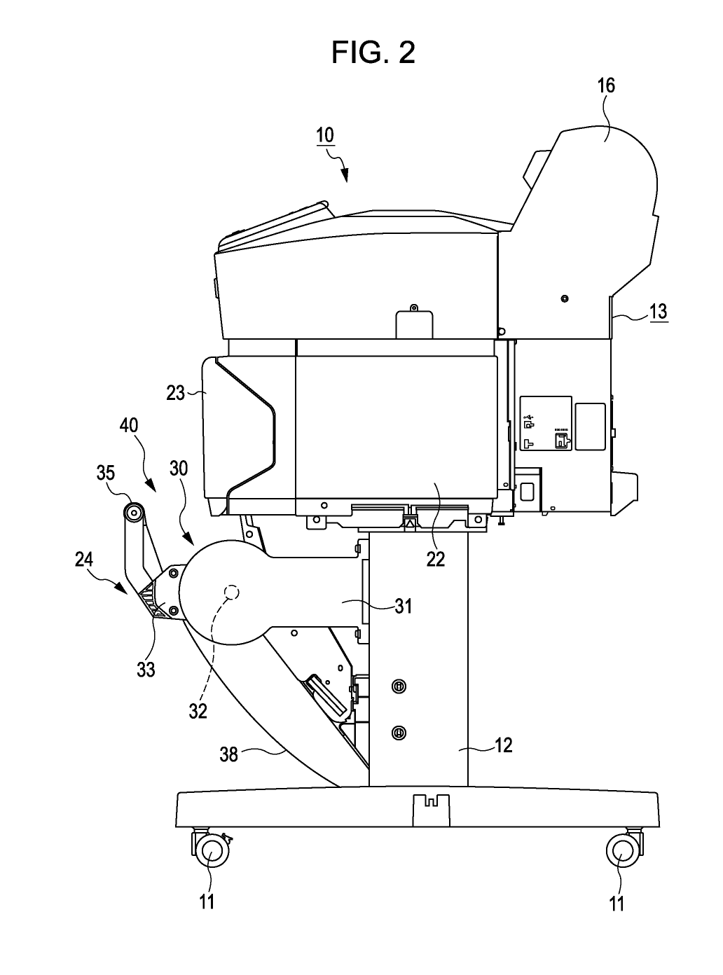

Next, a configuration of the medium receiving unit 24 will be described. As shown in FIGS. 1 and 2, rotative arm mechanisms 30 are disposed at the upper position of each of the pair of legs 12. Each rotative arm mechanism 30 includes a base 31 that extends horizontally forward from the leg 12 and an arm 33 that is connected to the base 31 so as to be rotatable about a rotation shaft 32 that extends in the width direction of the sheet S.

One of a pair of arms 33 which is positioned adjacent to the cartridge container 22 is formed such that a portion of the arm 33 that corresponds to the cartridge container 22 in the width direction of the sheet S has a substantially L-shape in front view. This prevents an opening movement of the cover 23 from being interfered by the arm 33. Moreover, a support shaft 35 horizontally extends in the width direction of the sheet S between each of the distal ends of the pair of arms 33.

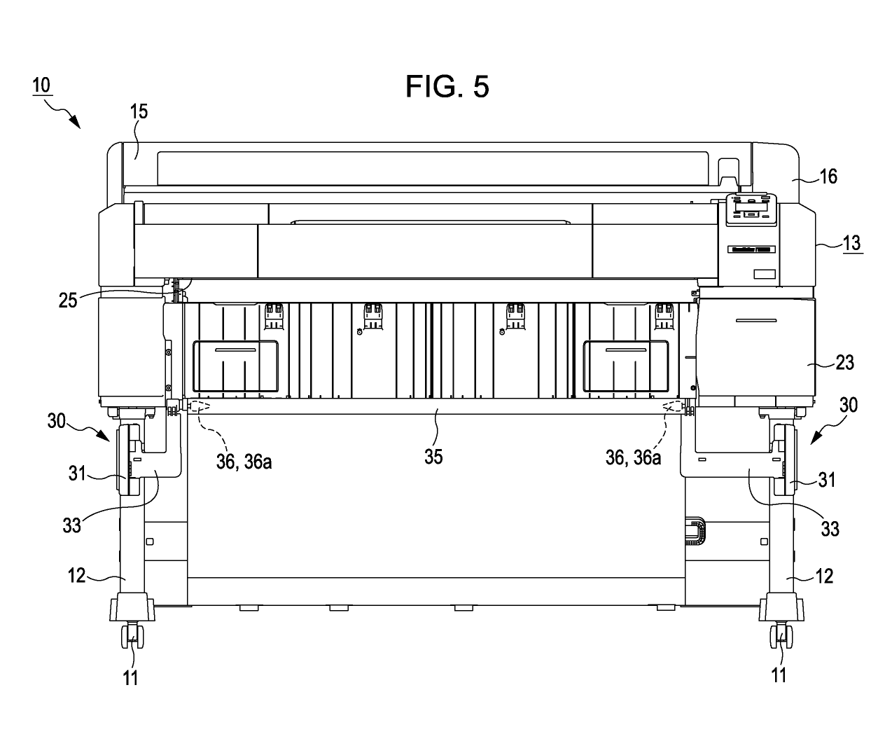

A pair of universal joints 36 (see FIG. 5) as an example of connection member are provided between each end of the support shaft 35 in the axial direction and the arm 33. The universal joint 36 has a fitting portion 36a having a spindle shape which fits in the hollow support shaft 35. A connection angle between the support shaft 35 and the arm 33 flexibly changes as the universal joint 36 deforms to displace the fitting portion 36a in a direction that intersects with the axial direction of the support shaft 35.

Further, a locking member (not shown in the figure) is provided at a fixed position so as to extend in the width direction of the sheet S between each of the pair of legs 12. A medium holding member 38 formed of a sheet material such as a fabric is hung between the support shaft 35 and the locking member. Accordingly, the support shaft 35 in this configuration serves as a support member that supports the medium holding member 38 capable of receiving and holding the sheet S which falls from the apparatus body 13. The leading edge of the sheet S comes into contact with the upper surface of the medium holding member 38, and then moves along the upper surface of the medium holding member 38 until it abuts and is locked by the locking member.

As shown in FIG. 2, when the medium receiving unit 24 receives the sheet S ejected from the ejection port 25 of the apparatus body 13, the arm 33 of the rotative arm mechanism 30 is held at a rotation position about the rotation shaft 32 in which the distal end of the arm 33 extends vertically upward. In this configuration, the support shaft 35 supported between the distal ends of the arms 33 is located at a position spaced forward from the lower end face of the apparatus body 13 and at the substantially same height as the lower end face of the apparatus body 13. A space between the support shaft 35 and the lower end face of the apparatus body 13 serves as a receiving port 40 for the sheet S ejected from the ejection port 25 of the apparatus body 13. That is, a position of the support shaft 35 shown in FIG. 2 is a receiving position for the sheets S ejected from the ejection port 25 of the apparatus body 13. The receiving position is a first position that allows the medium holding member 38 to be capable of receiving the sheets S.

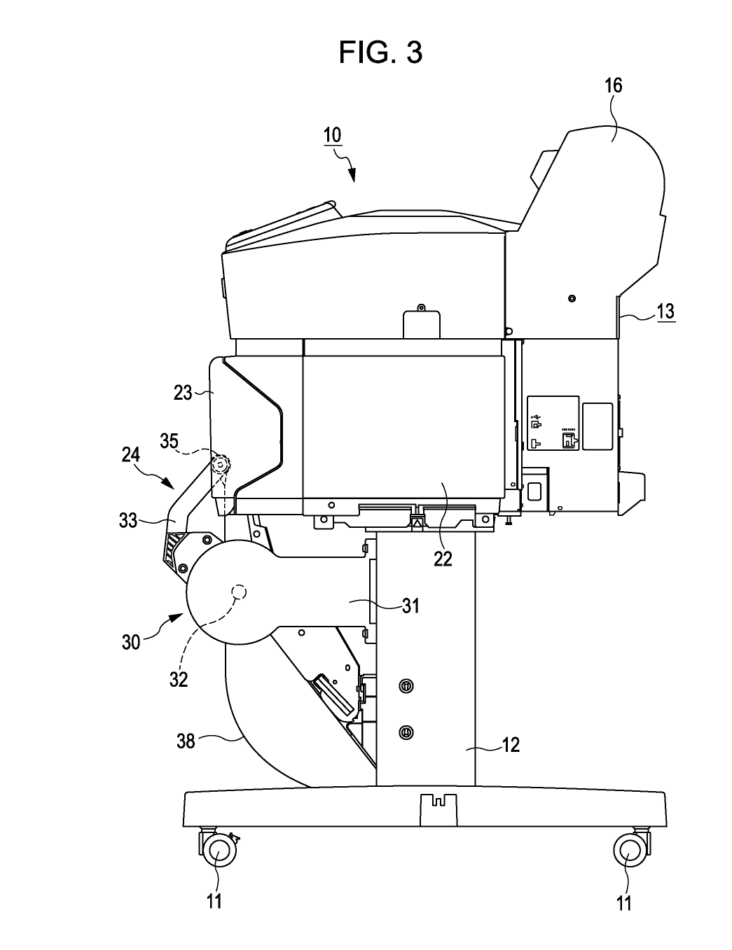

As shown in FIG. 3, when the support shaft 35 is lifted upward from the receiving position, the arm 33 rotates upward about the rotation shaft 32. The support shaft 35 supported between the distal ends of the arms 33 is located at a position closer to the apparatus body 13 in the front-back direction compared with the case where the support shaft 35 is positioned at the receiving position. In this configuration, the support shaft 35 is within an installation area of the apparatus body 13 in a projected view of the apparatus body 13 in the gravity direction. At this point, the support shaft 35 which is shown in FIG. 3 is in a storing position such that a distance from the apparatus body 13 to the arm 33 in the front direction in the storing position is smaller than that in the receiving position. The storing position is a second position that is spaced from the receiving position in a direction that intersects with the axial direction of the support shaft 35. Further, the rotative arm mechanism 30 serves as a displacement mechanism that displaces the support shaft 35 between the receiving position and the storing position. When the support shaft 35 is in the storing position, the recording apparatus 10 decreases its size in the horizontal direction with the support shaft 35 being not in use.

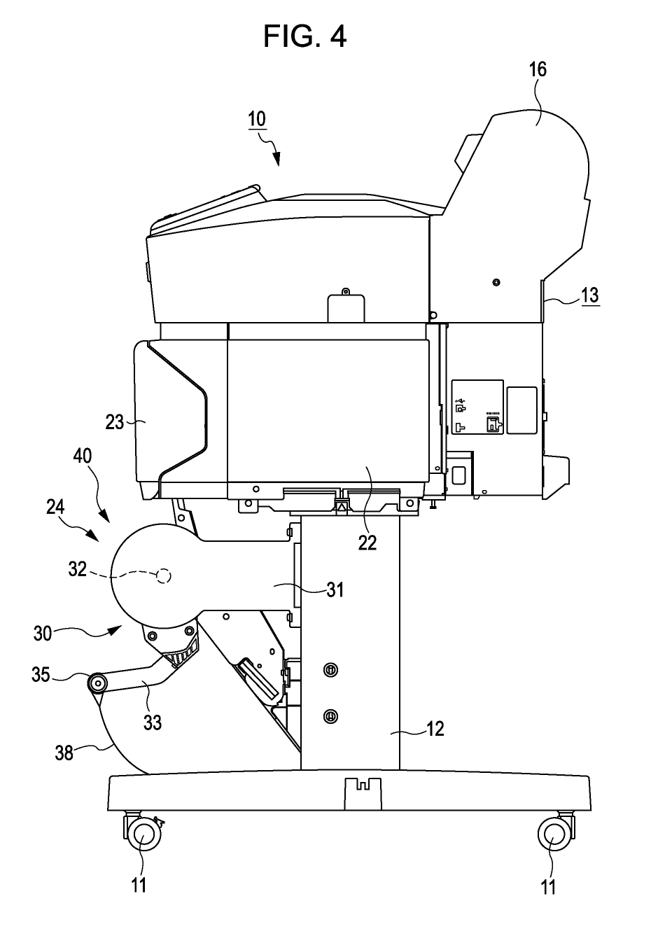

As shown in FIG. 4, when the support shaft 35 is pressed downward from the receiving position, the arm 33 rotates downward about the rotation shaft 32. The support shaft 35 that is supported between the distal ends of the arms 33 is located at a position which is largely spaced from the apparatus body 13 in the front-back direction compared with the case where the support shaft 35 is positioned at the receiving position. At this point, the position of the support shaft 35 shown in FIG. 4 is a picking-up position which is further spaced from the apparatus body 13 in a direction that intersects with the longitudinal direction of the support shaft 35 than the receiving position. The picking-up position is the second position that is spaced from the receiving position in a direction that intersects with the axial direction of the support shaft 35. Further, the rotative arm mechanism 30 serves as the displacement mechanism that displaces the support shaft 35 between the receiving position and the picking-up position. When the support shaft 35 is in the picking-up position, the size of the receiving port 40 for the sheets S formed between the support shaft 35 and the lower end face of the apparatus body 13 increases, and accordingly, the sheets S are easily picked-up from the medium receiving unit 24 through the wider receiving port 40.

Next, an operation of the above-mentioned recording apparatus 10 will be described below with reference to FIGS. 5 to 8, specifically focusing on an operation of the support shaft 35 moving from the receiving position to the picking-up position. Since the operation of the support shaft 35 moving from the receiving position to the storing position is similar to that of the support shaft 35 moving from the receiving position to the picking-up position, it is not further described. In FIGS. 5 to 8, part of the configuration of the medium receiving unit 24 is not shown for a convenience of description.

As shown in FIG. 5, when the support shaft 35 is in the receiving position, each of the distal ends of the pair of arms 33 are positioned at the substantially same height with each other. The support shaft 35 assumes a horizontal position in the width direction of the sheet S. In this configuration, the pair of universal joints 36 are disposed on each end of the support shaft 35 in the axial direction of the support shaft 35 such that the distal ends of the fitting portion 36a oppose each other in the horizontal direction which is in the axial direction of the support shaft 35. That is, when the support shaft 35 is in the receiving position, the pair of universal joints 36 assume a first connection state in which the support shaft 35 and the rotative arm mechanism 30 are coaxially connected in the width direction of the sheet S.

The rotative arm mechanism 30 of this embodiment has an increased holding force for holding the support shaft 35 at the receiving position so that a plurality of sheets S ejected from the apparatus body 13 can be loaded and stored on the medium holding member 38. As a consequence, a large load is applied to the support shaft 35 when it is displaced from the receiving position to the picking-up position against the holding force of the rotative arm mechanism 30.

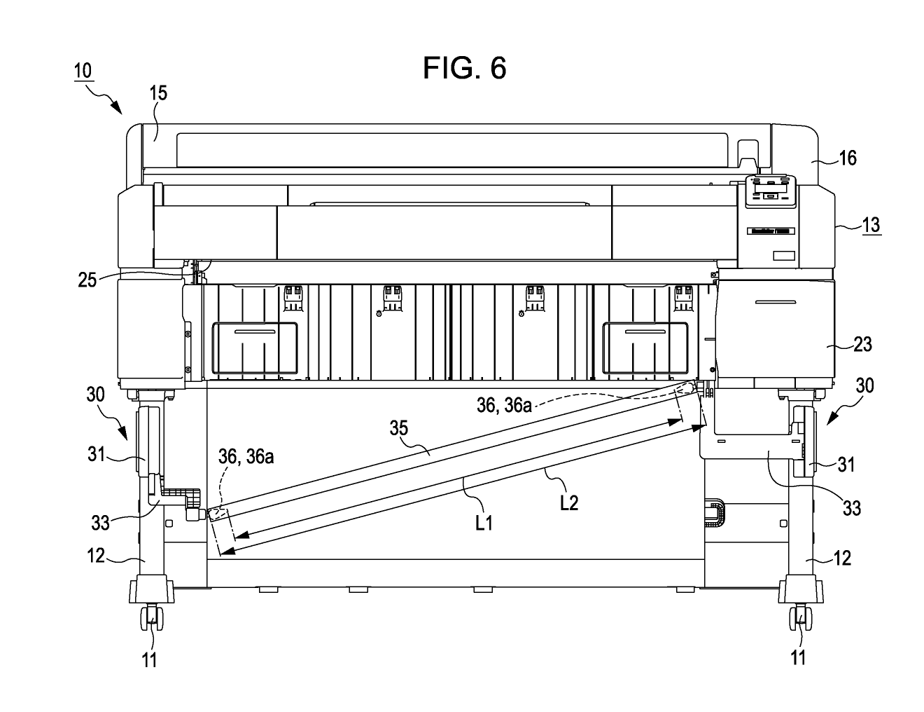

In this embodiment, when the support shaft 35 is moved from the receiving position as shown in FIG. 6, each end of the support shaft 35 in the axial direction is displaced one by one from the receiving position. That is, while the arm 33 disposed on one end of the support shaft 35 in the axial direction (on the right side in FIG. 6) is not rotated about the rotation shaft 32, the arm 33 disposed on the other end of the support shaft 35 in the axial direction (on the left side in FIG. 6) is rotated downward about the rotation shaft 32. Accordingly, while one end of the support shaft 35 in the axial direction (the right end in FIG. 6) is not displaced from the receiving position, the other end of the support shaft 35 in the axial direction (the left end in FIG. 6) is displaced from the receiving position to the picking-up position. Since distal ends of the pair of arms 33 are positioned at different heights, the support shaft 35 is inclined relative to the width direction of the sheet S.

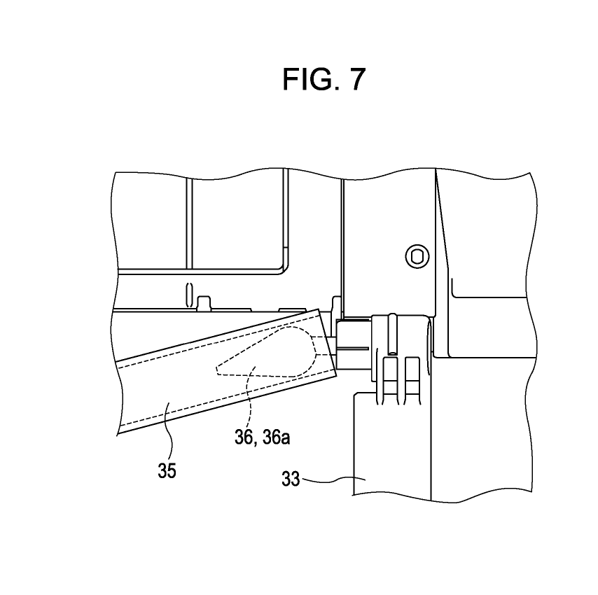

As shown in FIG. 7, in this configuration, the universal joint 36 deforms as the support shaft 35 is inclined, thereby allowing a connection angle between the support shaft 35 and the arm 33 to be changed. Consequently, when each end of the support shaft 35 in the axial direction is displaced one by one from the receiving position to the picking-up position while the support shaft 35 and the rotative arm mechanism 30 remain to be connected, a connection between the support shaft 35 and the rotative arm mechanism 30 is prevented from being distorted. Each of the distal ends of the fitting portions 36a of the pair of universal joints 36 oppose each other in the axial direction of the support shaft 35 which is inclined relative to the width direction of the sheet S. Accordingly, when one end of the support shaft 35 is displaced from the receiving position to the picking-up position, the pair of universal joints 36 assume a second connection state in which the support shaft 35 and the rotative arm mechanism 30 are non-coaxially connected in the width direction of the sheet S.

In this configuration, a distance L1 between the fitting portions 36a of the pair of universal joints 36 is longer than a length L2 of the support shaft 35 in the axial direction. Accordingly, when each end of the support shaft 35 in the axial direction is displaced one by one from the receiving position to the picking-up position, the support shaft 35 is prevented from being disengaged from the fitting portion 36a of the universal joint 36.

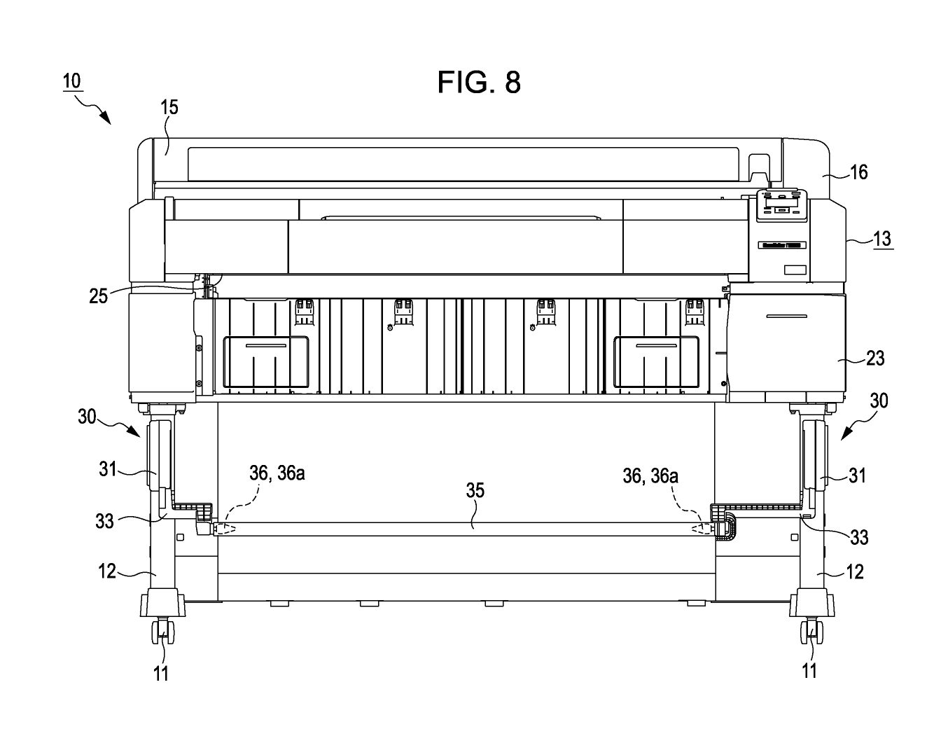

Then, as shown in FIG. 8, when the arm 33 disposed on one end of the support shaft 35 in the axial direction (on the right side in FIG. 8) is rotated downward about the rotation shaft 32, one end of the support shaft 35 in the axial direction (the right end in FIG. 8) is displaced from the receiving position to the picking-up position. As a result, since distal ends of the pair of arms 33 are positioned at the substantially same height, the support shaft 35 is positioned at the picking-up position and assumes the horizontal position in the width direction of the sheet S.

According to the above-mentioned embodiment, the following effect can be achieved:

(1) Even if the support shaft 35 is inclined during a process in which each end of the support shaft 35 in the longitudinal direction is displaced one by one from the receiving position, the support shaft 35 and the rotative arm mechanism 30 remain to be connected since the pair of universal joints 36 deform as the support shaft 35 is inclined. Accordingly, even if the holding force for holding the support shaft 35 at the receiving position is increased in order to hold the sheets S in a stable manner, it is possible to displace each end of the support shaft 35 in the longitudinal direction one by one from the receiving position while the support shaft 35 and the rotative arm mechanism 30 remain to be connected. Accordingly, the support shaft 35 that supports the medium holding member 38 capable of receiving and holding the ejected sheets S can be displaced in a stable manner from the receiving position in which the medium holding member 38 is capable of receiving the sheets S.

(2) When each end of the support shaft 35 in the longitudinal direction is displaced one by one from the receiving position, the end of the support shaft 35 is not disengaged from the universal joint 36. Accordingly, when the support shaft 35 is displaced from the receiving position, a configuration can be achieved in which the support shaft 35 and the rotative arm mechanism 30 can remain to be connected by the pair of universal joints 36.

(3) Even if the holding force for holding the support shaft 35 at the receiving position is increased in order to hold the sheets S in a stable manner, handleability of the support shaft 35 being displaced from the receiving position to the storing position can be increased by displacing each end of the support shaft 35 in the longitudinal direction one by one from the receiving position to the storing position.

(4) Even if the holding force for holding the support shaft 35 at the receiving position is increased in order to hold the sheets S in a stable manner, handleability of the support shaft 35 being displaced from the receiving position to the picking-up position can be increased by displacing each end of the support shaft 35 in the longitudinal direction one by one from the receiving position to the picking-up position.

The following modifications may be made to the above-mentioned embodiment:

In the above-mentioned embodiment, the connection member that connects the support shaft 35 and the rotative arm mechanism 30 is not limited to the universal joint 36, and any mechanism capable of connecting the support shaft 35 and the rotative arm mechanism 30 while allowing the connection angle to be flexibly changed may be used.

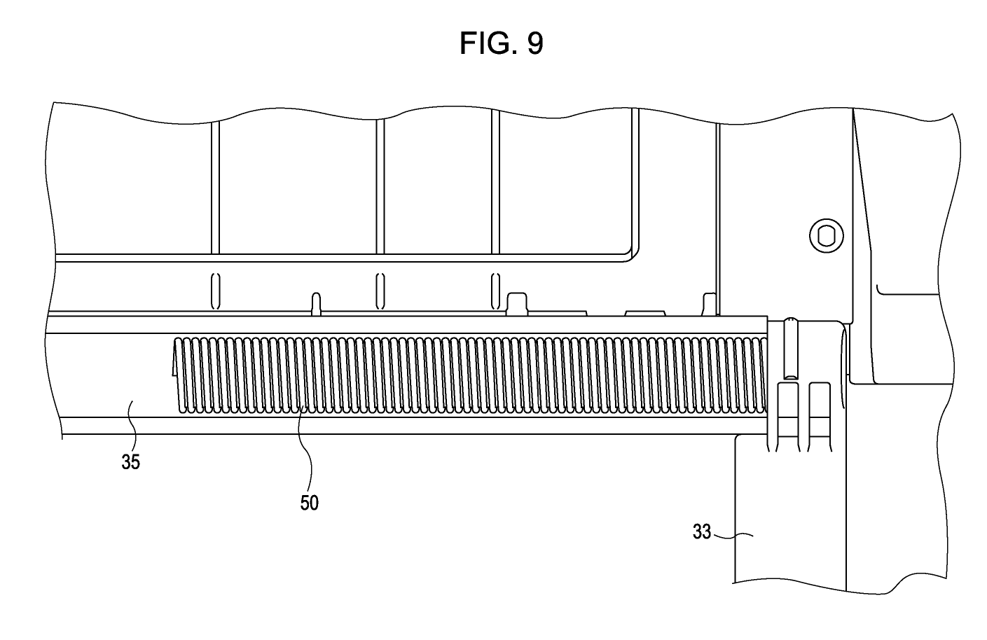

As shown in FIG. 9, for example, a coil spring 50 may be used as an example of connection member that connects the support shaft 35 and the rotative arm mechanism 30. With this configuration, the coil spring 50 elastically deforms in a direction that intersects with the axial direction of the support shaft 35, thereby allowing the connection angle between the support shaft 35 and the arm 33 to be flexibly changed.

In the above-mentioned embodiment, the support shaft 35 may be configured not to rotate upward from the receiving position about the rotation shaft 32 and not to be displaced from the receiving position to the storing position.

In the above-mentioned embodiment, the support shaft 35 may be configured not to rotate downward from the receiving position about the rotation shaft 32 and not to be displaced from the receiving position to the picking-up position.

In the above-mentioned embodiment, in a state that one end of the support shaft 35 in the axial direction is positioned at the receiving position and the other end of the support shaft 35 in the axial direction is positioned at the picking-up position, a distance between each of the pair of universal joints 36 may be approximately the same as the length of the support shaft 35 in the axial direction, or alternatively, may be smaller than the length of the support shaft 35 in the axial direction.

Although the recording apparatus is embodied as a recording apparatus 10 having the recording head 19 that ejects ink as an example of liquid in the above-mentioned embodiment, the invention may also be embodied as a liquid ejection apparatus that ejects liquid other than ink. The invention may be applied to a variety of liquid ejection apparatuses having a liquid ejection head that ejects fine liquid droplets. The liquid droplets refer to a state of liquid that is ejected from the liquid ejection apparatuses and are intended to include those in a particle, tear drop or string shape. The liquid as described herein may be any material that can be ejected from liquid ejection apparatuses. For example, it may include a material in liquid phase such as liquid having high or low viscosity, sol, gel water, other inorganic solvent, organic solvent and liquid solution, and a material in melted state such as liquid resin and liquid metal (molten metal). Further, in addition to a material in a liquid state, it may include particles of functional material made of solid substance such as pigment and metal particles, which is dissolved, dispersed or mixed in a solvent. Further, typical examples of liquid include ink as mentioned above, liquid crystal and the like. The ink as described herein includes various liquid components such as general water-based ink, oil-based ink, gel ink and hot melt ink. Specific examples of liquid ejection apparatus may include, for example, liquid ejection apparatuses that eject liquid containing materials such as electrode material and color material in a dispersed or dissolved state, which are used for manufacturing of liquid crystal displays, electro-luminescence (EL) displays, surface emitting displays or color filters. Alternatively, they may include liquid ejection apparatuses that eject bioorganic materials used for manufacturing biochips, liquid ejection apparatuses that are used as a precision pipette and eject liquid of a sample, textile printing apparatuses and micro dispensers. Further, they may also include liquid ejection apparatuses that eject lubricant to precision instrument such as a clock or camera in a pin-point manner, liquid ejection apparatuses that eject transparent resin liquid such as ultraviolet cured resin onto a substrate for manufacturing minute hemispheric lenses (optical lenses) used for optical communication elements or the like, and liquid ejection apparatuses that eject acid or alkali etching liquid for etching a substrate or the like. The invention may be applied to any one of the above-mentioned liquid ejection apparatuses.

In the above-mentioned embodiment, the medium receiving unit 24 is not necessarily provided in the recording apparatus. For example, the invention may be applied to the medium receiving unit 24 that receives a medium on which recording has been performed at a position lower in the gravity direction.

The entire disclosure of Japanese Patent Application No.2012-102533, filed Apr. 27, 2012 is expressly incorporated by reference herein.

What is claimed is:

1. A medium receiving device that receives a medium which is ejected and falls from a medium ejection unit at a position lower than the medium ejection unit in the gravity direction, comprising:
a support member that extends in a width direction of the medium that intersects with an ejection direction of the medium at a position spaced from the medium ejection unit and supports a medium holding member that is capable of holding the medium which falls on the medium holding member;
a displacement mechanism that is disposed at each end of the support member in the longitudinal direction and allows the support member to be displaced between a first position in which the medium holding member is capable of receiving the medium and a second position which is spaced from the first position in a direction that intersects with the longitudinal direction of the support member; and
a pair of connection members that connect the support member and the displacement mechanism, wherein the pair of connection members are configured to deform to a first connection state in which the support member and the displacement mechanism are connected in a coaxial arrangement in the width direction of the medium and a second connection state in which the support member and the displacement mechanism are connected in a non-coaxial arrangement in the width direction of the medium.

2. The medium receiving device according to claim 1, wherein, in a state that one end of the support member in the longitudinal direction is positioned at the first position and the other end of the support member in the longitudinal direction is positioned at the second position, a distance between each of the pair of connection members is smaller than a dimension of the support member in the longitudinal direction.

3. The medium receiving device according to claim 1, wherein the second position is located within an installation area of the medium ejection unit when the support member projects the medium ejection unit in the gravity direction.

4. The medium receiving device according to claim 1, wherein the second position is spaced from the medium ejection unit in the direction that intersects with the longitudinal direction of the support member by a distance larger than the first position.

5. A recording apparatus comprising:
a recording unit that performs recording on a medium; and
the medium receiving device according to claim 1 that receives the medium on which recording has been performed by the recording unit.

6. A recording apparatus comprising:
a recording unit that performs recording on a medium; and
the medium receiving device according to claim 2 that receives the medium on which recording has been performed by the recording unit.

7. A recording apparatus comprising:
a recording unit that performs recording on a medium; and
the medium receiving device according to claim 3 that receives the medium on which recording has been performed by the recording unit.

8. A recording apparatus comprising:
a recording unit that performs recording on a medium; and
the medium receiving device according to claim 4 that receives the medium on which recording has been performed by the recording unit.
